(19) United States
(12) Patent Application Publication
(10) Pub. No.: US 2010/0150618 A1
(43) Pub. Date: Jun. 17, 2010

(54) DEVELOPING ROLLER, DEVELOPING DEVICE, IMAGE FORMING APPARATUS, AND DEVELOPING ROLLER MANUFACTURING METHOD

(75) Inventors: Yoshiyuki KUREBAYASHI, Shiojiri-shi (JP); Masahiro MAEDA, Matsumoto-shi (JP); Yoichi YAMADA, Shiojiri-shi (JP); Daisuke MATSUMOTO, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/620,687

(22) Filed: Nov. 18, 2009

(30) Foreign Application Priority Data
Dec. 11, 2008 (JP) 2008-315586

(51) Int. Cl. G03G 15/08

(52) U.S. Cl. 399/286

(57) ABSTRACT

A developing roller having a first inclined groove and a second inclined groove, which are continuous in a helical shape inclined with respect to an axial direction and a circumferential direction and which intersect with each other, formed in the surface thereof, wherein the first inclined groove and the second inclined groove have different groove depths.

### BACKGROUND

1. Technical Field

The present invention relates to a developing roller, a developing device, an image forming apparatus, and a developing roller manufacturing method.

2. Related Art

In an image forming apparatus using nonmagnetic mono-component toner, an electric charge is given to toner on a developing roller by frictional electrification. In order to effectively generate the frictional electrification, in JP-A-2001-66876, there is disclosed a developing roller in which blast processing is carried out on the developing roller, so that a given surface roughness Rz is given to the surface of the developing roller, whereby toner can be effectively rubbed against the developing roller.

However, the recess portions formed by the blast processing are not uniform in size, depth, shape, or array. For this reason, there is a probability that toner entering a deep recess portion cannot be rolled, so that it cannot be effectively electrically charged. In this manner, there is a probability that filming will occur due to the unevenness of the concave-convex portions of the developing roller surface. Further, in the case where toner is not effectively electrically charged, there is also a problem that the toner leaks from the developing device, thereby being dispersed in an image forming apparatus, or there may be ground fogging of an image.

Therefore, in order to improve the electrical charging of toner, in JP-A-2007-121947, there is disclosed a developing roller in which grooves regularly arrayed in a lattice shape on the developing roller are formed by a rolling process, and a manufacturing method thereof. It has been reported that a developing roller with grooves formed by a rolling process has improved electrical charging compared to conventional developing rollers having an irregular surface state due to blast processing.

On the other hand, in the developing roller in which the grooves arranged in a regular lattice shape are formed by a rolling process, toner is accumulated in the groove portions formed in the surface. A toner transportation amount which is a parameter closely concerning the flying of toner is controlled by a groove depth. Also, the control of the toner electrification amount is performed by the number of toner contacts with the concave-convex shape of the surface of the developing roller at a certain length at the time when toner moves toward the circumferential direction of the developing roller. The deeper the groove, the more the toner transportation amount is increased, and the more the number of toner contacts with the concave-convex shape is increased, the more the toner electrification amount is increased.

When an attempt to secure the toner transportation amount by making the groove depth large has been made, the electrification amount is lowered by the reduction of the number of toner contacts with the concave-convex shape. Conversely, when making the groove depth small, the toner electrification amount is increased, but as a matter of course, the toner transportation amount is reduced. In this manner, the toner transportation amount and the toner electrification amount have a trade-off relationship, and thus a method of improving the toner electrification amount by increasing the number of toner contacts with the concave-convex shape, while maintaining the toner transportation amount by making the groove depth large, is required.

### SUMMARY

An advantage of some aspects of the invention is that it provides a developing roller in which it is possible to increase the toner electrification amount while securing the toner transportation amount, a developing device, an image forming apparatus, and a developing roller manufacturing method.

According to a first aspect of the invention, there is provided a developing roller having a first inclined groove and a second inclined groove, which are continuous in a helical shape inclined with respect to an axial direction and a circumferential direction and which intersect with each other, formed in the surface thereof, wherein the first inclined groove and the second inclined groove have different groove depths. Therefore, it is possible to secure a toner transportation amount by maintaining a groove depth, and also obtain high electrical charging by increasing the number of toner contacts with a groove step portion.

Further, in the developing roller according to an aspect of the invention, the groove depths of the first and second inclined grooves are larger than the volume average grain diameter R of toner. Therefore, the toner transportation amount may be reliably secured by maintaining and transporting a certain amount of toner along the groove depth.

Further, in the developing roller according to the aspect, the height of a groove step portion formed at the intersection portion of the first and second inclined grooves having different groove depths is smaller than the volume average grain diameter of the toner and larger than the maximum grain diameter of an external additive. By making the height H of the groove step portion smaller than the volume average grain diameter of the toner, the movement of toner passing over the groove step portion becomes possible. Further, by making the height H of the groove step portion larger than the maximum grain diameter of the external additive, the toner may reliably contact the groove step portion.

Further, in the developing roller according to this aspect, the angle θb of the inclined groove having a smaller groove depth, of the first and second inclined grooves, with respect to the circumferential direction of the developing roller, is smaller than the angle θa of the inclined groove having a larger groove depth with respect to the circumferential direction of the developing roller. By making the angle of the inclined groove having a smaller groove depth with respect to the circumferential direction of the developing roller small, the toner supplied with the rotation of a supply roller preferentially passes over the groove step portion from the groove having a larger groove depth to the groove having a smaller groove depth. Due to the fact that the toner passes over the step, the number of toner contacts with the concave-convex shape in the groove is increased, so that the toner electrification amount may be effectively improved.

Further, in the developing roller according to the aspect, toner is transported in the groove portions of the first and second inclined grooves. By the toner contact with the step portion in the groove according to the movement of toner, along with the electrical charging by a regulating blade which regulates the amount of toner on the developing roller, the improvement of the electrical charging of the toner becomes possible. Further, by maintaining and transporting the toner along the groove depth, the toner transportation amount may be reliably secured.

Further, in the developing roller according to this aspect, as the toner, a small grain diameter toner having the volume average grain diameter of 5 μm or less is used. Therefore, a higher quality image may be realized. In addition, the small grain diameter toner having higher electrical charging than a large grain diameter toner is suitable for transportation in the groove due to the action of an image force when the developing roller is electrically conductive.

Also, according to a second aspect of the invention, there is provided a developing device including: a supply roller which supplies toner; a developing roller to which the toner is supplied from the supply roller; and a regulating blade which comes into contact with the developing roller, thereby regulating the total thickness of the toner layer on the developing roller, wherein as the developing roller, the developing roller according to the first aspect is used. By maintaining the toner transportation amount and increasing the number of toner contacts with a groove step portion, high electrical charging may be obtained.

Also, according to a third aspect of the invention, there is provided an image forming apparatus including: a latent image supporting body on which an electrostatic latent image is formed; a developing device which develops a toner image on the latent image supporting body by developing the electrostatic latent image by using toner; and a transferring device which transfers the toner image on the latent image supporting body to a transfer medium, wherein the developing device is the developing device according to the second aspect. Since it is possible to improve the toner electrification amount while maintaining the toner transportation amount in the developing device, a high quality image may be obtained.

Also, according to a fourth aspect of the invention, there is provided a method of manufacturing a developing roller, including: a rolling process including rotating a first die having first inclined blades inclined with respect to axial and circumferential directions, and a second die having second inclined blades which are inclined with respect to axial and circumferential directions in the direction opposite to that of the first inclined blade, in the same direction, and feeding an unprocessed developing roller between the first die and the second die while rotating the developing roller in the direction opposite to the rotation directions of the first and second dies and applying a working pressure to the developing roller, wherein the height at which the first inclined blade protrudes from a surface and the height at which the second inclined blade protrudes from a surface, are different from each other. Therefore, first and second inclined grooves having highly precise groove shapes and groove depths may be formed in the surface of the developing roller.

Also, according to a fifth aspect of the invention, there is provided a method of manufacturing a developing roller, including: a first rolling process for forming a first inclined groove which is continuous in a helical shape, by rotating a first die having blades inclined with respect to axial and circumferential directions, and a non-bladed die in the same direction, and feeding an unprocessed developing roller between the first die and the non-bladed die while rotating the developing roller in the direction opposite to the rotation directions of the first die and the non-bladed die and applying a first working pressure to the developing roller; and a second rolling process for forming a second inclined groove which is continuous in a helical shape and intersects with the first inclined groove, by rotating a second die having blades inclined with respect to axial and circumferential directions in the direction opposite to that of the first die, and the non-bladed die in the same direction as that in the first rolling process, and feeding the developing roller on which the first inclined groove has been formed, between the second die and the non-bladed die while rotating the developing roller in the same direction as that in the first rolling process and applying a second working pressure to the developing roller, wherein the magnitudes of the first working pressure and the second working pressure are varied. Therefore, the first and second inclined grooves having highly precise groove shapes and groove depths may be formed in the surface of the developing roller.

Further, in the developing roller manufacturing method according to the above aspects, the angle of the inclined blade which forms the inclined groove having a larger groove depth, of the first and second inclined blades, with respect to the circumferential direction of the developing roller is larger than the angle of the other inclined blade with respect to the circumferential direction of the developing roller. Therefore, it is possible to form the developing roller in which the toner electrification amount may be effectively improved by the increase of the number of toner contacts with a step due to the fact that the toner passes over the groove having a step (groove having a small groove depth).

### BRIEF DESCRIPTION OF THE DRAWINGS

The invention will be described with reference to the accompanying drawings, wherein like numbers reference like elements.

FIG. 1 is a diagram illustrating the overall structure of an image forming apparatus according to an embodiment of the invention.

FIGS. 2A and 2B are diagrams illustrating a developing device according to an embodiment of the invention.

FIG. 3 is a diagram illustrating a developing roller according to an embodiment of the invention along with a partly enlarged view of the surface thereof.

FIGS. 4A, 4B, and 4C are diagrams for explaining the action of a groove step portion.

FIG. 5 is a diagram showing an example in which the angles of two intersecting inclined grooves with respect to a circumferential direction has been varied.

FIG. 6 is a diagram showing the result of an experiment that compared the toner transportation amounts and the toner electrification amounts in the developing roller with the groove step portion and the developing roller without the groove step portion.

FIG. 7 is a diagram showing Example 1 of the rolling process for forming the intersecting inclined grooves having different groove depths in the developing roller.

FIGS. 8A and 8B are diagrams showing Example 2 of the rolling process for forming the intersecting inclined grooves having different groove depths in the developing roller.

### DESCRIPTION OF EXEMPLARY EMBODIMENTS

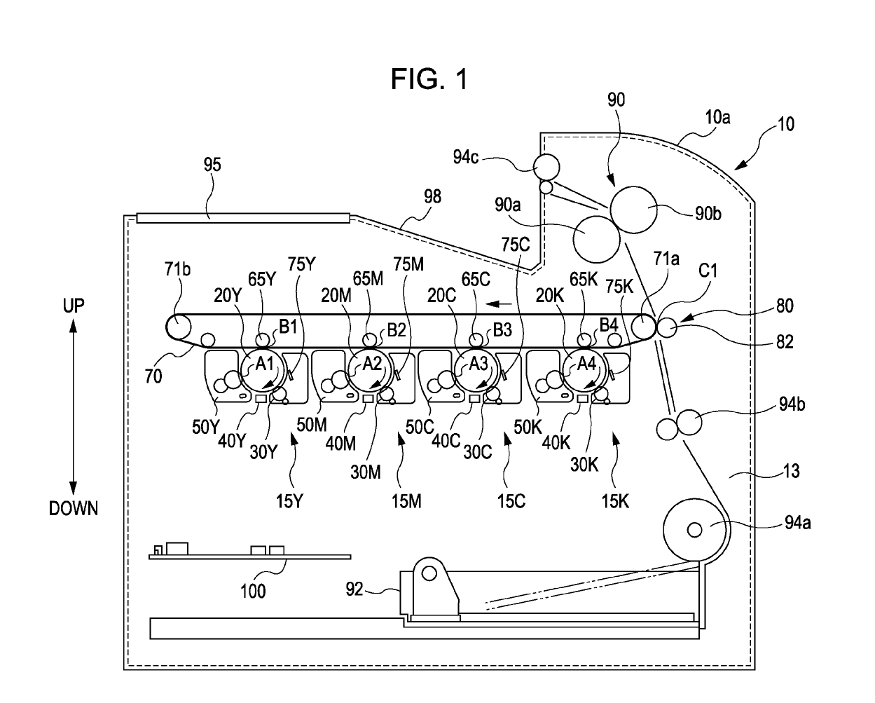

Hereinafter, embodiments of the invention will be explained based on the drawings. FIG. 1 is a diagram schematically illustrating an image forming apparatus according to an embodiment of the invention.

As shown in FIG. 1, the image forming apparatus 10 includes four image forming stations 15Y, 15M, 15C, and 15K; an intermediate transferring belt 70; a secondary transferring unit 80; a fixing unit 90; a display unit 95 which is configured of a liquid crystal panel constituting a means of messaging to a user; and a control unit 100 which controls these units and the like and manages the operation of the image forming apparatus. The image forming stations 15Y, 15M, 15C, and 15K respectively have functions for forming images by yellow (Y), magenta (M), cyan (C), and black (K) toner. Since the image forming stations 15Y, 15M, 15C, and 15K have the same configuration, only the image forming station 15Y is explained below.

As shown in FIG. 1, the image forming station 15Y has an electrical charging unit 30Y, an exposure unit 40Y, a developing unit 50Y, and a primary transferring unit along the rotation direction of a photo conductor 20Y used as one example of an image supporting body.

The photo conductor 20Y has a cylindrical substrate and a photosensitive layer formed on the outer circumferential surface of the substrate. The photo conductor 20Y can rotate about a central axis, and in this embodiment, rotates in a clockwise direction, as indicated by an arrow.

The electrical charging unit 30Y is a device for electrically charging the photo conductor 20Y. A latent image is formed on the electrically charged photo conductor 20Y by the irradiation of a laser from the exposure unit 40Y.

The exposure unit 40Y includes a semiconductor laser, a polygon mirror, a F-θ lens, and the like, and irradiates the electrically charged photo conductor 20Y with a modulated laser on the basis of the image signals input from a host computer (not shown) such as a personal computer, a word processor, or the like.

The developing unit 50Y is a device for developing the latent image on the photo conductor 20Y by using yellow toner (Y). The developing unit 50Y includes a developing roller 51Y and a supply roller 52Y, which are disposed in a developing chamber which is supplied with toner from a exchangeable toner cartridge, and a regulating blade 53Y comes into contact with the developing roller 51Y for creating a thin layer of toner on the developing roller 51Y.

The primary transferring unit transfers the yellow toner image formed on the photo conductor 20Y to the intermediate transferring belt 70 by the application of a primary transferring bias from a primary transferring roller 65Y in a primary transferring section B1. When the toners of four colors have been sequentially transferred in layers by the respective primary transferring sections B1, B2, B3, and B4, a full-color toner image is formed on the intermediate transferring belt 70.

The intermediate transferring belt 70 is an endless belt which is mounted to pass around a belt driving roller 71a and a driven roller 71b, and is rotationally driven while coming into contact with the photo conductors 20Y, 20M, 20C, and 20K.

The secondary transferring unit 80 is a device for transferring a monochromatic toner image or a full-color toner image formed on the intermediate transferring belt 70 to a transfer material such as paper, film, cloth, or the like.

The fixing unit 90 is a device constituted of a fixing roller 90a and a pressurizing roller 90b, and acts to fuse and bond the monochromatic toner image or the full-color toner image transferred to the transfer material, to the transfer material, thereby making the image a permanent image.

Next, the operation of the image forming apparatus 10 configured as described above will be explained. First, when image signals or control signals from a host computer (not shown) are inputted to a main controller of the image forming apparatus through an interface, the photo conductor 20Y, the developing roller 51Y provided in the developing unit 50Y, the intermediate transferring belt 70, and the like rotate due to the control of a unit controller on the basis of the commands from the main controller. The photo conductor 20Y is electrically charged in sequence by the electrical charging unit 30Y at an electrical charging position while being rotated.

When the electrically charged region of the photo conductor 20Y has reached an exposure position with the rotation of the photo conductor 20Y, a latent image according to the yellow Y image information is formed on the region by the exposure unit 40Y. When the latent image formed on the photo conductor 20Y has reached a developing position with the rotation of the photo conductor 20Y, the image is developed by the developing unit 50Y. Thus, a toner image is formed on the photo conductor 20Y.

When the toner image formed on the photo conductor 20Y has reached the position of the primary transferring section B1 with the rotation of the photo conductor 20Y, the image is transferred to the intermediate transferring belt 70 by the primary transferring unit. At this time, in the primary transferring unit, a primary transferring voltage having the opposite polarity to the electrical charge polarity of toner is applied from the primary transferring roller 65Y. As a result, the toner images of four colors formed on the respective photo conductors 20Y, 20M, 20C, and 20K are transferred in layers to the intermediate transferring belt 70, so that the full-color toner image is formed on the intermediate transferring belt 70.

The intermediate transferring belt 70 is driven by the driving force from a belt driving means such as a motor, which is transmitted thereto through the belt driving roller 71a.

The full-color toner image formed on the intermediate transferring belt 70 is transferred to the transfer material such as paper by the secondary transferring unit 80. This transfer material is transported to the secondary transferring unit 80 from a paper feed tray through a paper feed roller 94a and a resist roller 94b.

The full-color toner image transferred to the transfer material is fused and bonded to the transfer material by heating and pressurizing by the fixing unit 90. Then, the transfer material passes through the fixing unit 90, and then is discharged by a paper discharging roller 94c.

On the other hand, after the photo conductors 20Y, 20M, 20C, and 20K have passed over the positions of the primary transferring sections B1, B2, B3, and B4, they are subjected to a process for removing electrical charge by a neutralization unit (not shown), thereby being prepared for the electrical charging in order to form the next latent image.

On the driven roller 71b side of the intermediate transferring belt 70 after the secondary transferring, there is provided an intermediate transferring belt cleaning device (not shown) used to clean the intermediate transferring belt 70 after the secondary transferring.

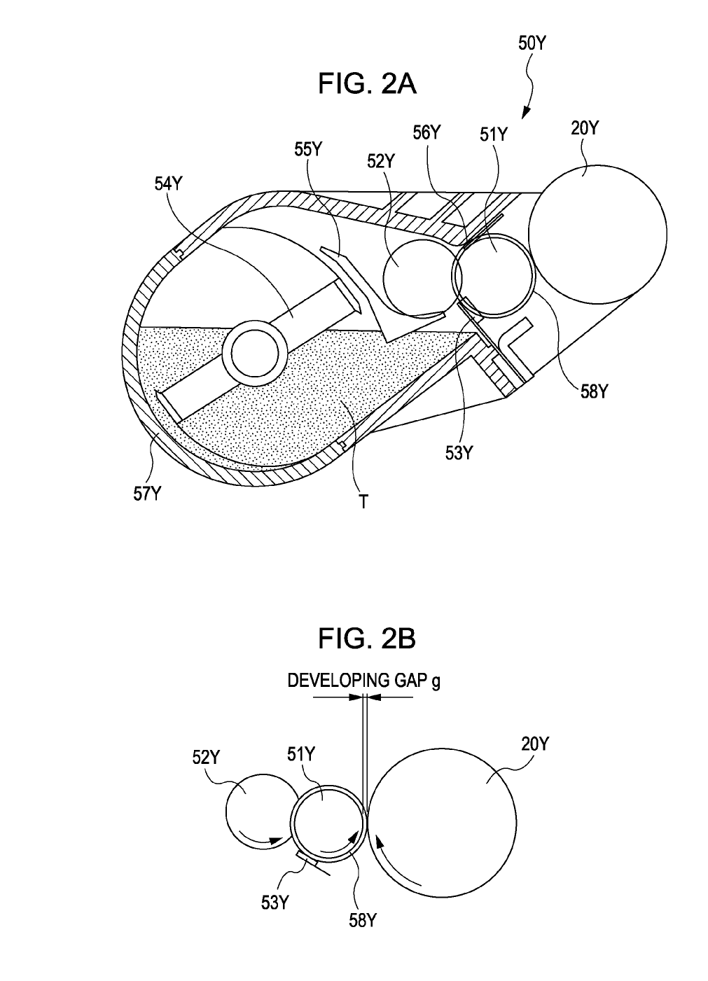

FIG. 2A is a schematic view showing one example of the developing unit 50Y according to the invention, and FIG. 2B is a view showing a part of the developing unit 50Y.

The developing unit 50Y includes the developing roller 51Y which transports the toner T to the photo conductor 20Y; the supply roller 52Y which comes into pressure-contact with the developing roller 51Y so as to supply the toner T; the regulating blade 53Y which comes into contact with the developing roller 51Y so as to regulate the toner T transported to the photo conductor 20Y; a toner agitating and transporting member 54Y which agitates and transports the toner T; a toner receiving member 55Y which receives the toner T transported by the toner agitating and transporting member 54Y and guides the toner T toward the supply roller 52Y; a seal member 56Y which comes into contact with the developing roller 51Y in a direction which recovers the remaining toner T after the development so as to prevent toner leakage; and a case 57Y which contains the toner T.

The developing roller 51Y is formed into a cylindrical shape from material able to conduct electricity such as metal or alloy including copper, aluminum, stainless steel, or the like. The supply roller 52Y is formed into a cylindrical shape from an elastic material such as foamed urethane rubber or silicone rubber, or formed as a brush roller with a cylindrical core wrapped with a hair-transplanted sheet. The developing roller 51Y and the supply roller 52Y rotate in contact with each other, whereby the toner T is supplied to the developing roller 51Y, so that the toner layer of a given thickness is formed on the developing roller 51Y. Due to the regulating blade 53Y which comes into contact with the developing roller 51Y supplied with the toner T, the total thickness of the toner T on the developing roller 51Y is regulated. Toner particles move on the developing roller 51Y and an electric charge is given to them by frictional electrification by contact with the concave-convex shape of the developing roller 51Y.

A spacer 58Y is fixed on each of the opposite ends of the developing roller 51Y. These spacers 58Y are brought into contact with the image non-supporting surfaces of the photo conductor 20Y, so that a developing gap g is formed between the toner transporting surface of the developing roller 51Y and the image supporting surface of the photo conductor 20Y, which faces the toner transporting surface.

Further, the developing gap g is adjusted to a desired size by appropriately selecting the thicknesses of the spacers 58Y. Therefore, this developing device performs nonmagnetic mono-component developer non-contact jumping development using the toner T which is a nonmagnetic mono-component developer. In this case, in this embodiment, as shown in FIG. 2B, the setting is adjusting such that the photo conductor 20Y rotates in the clockwise direction and both the developing roller 51Y and the supply roller 52Y rotate in the counter-clockwise direction. Also, the setting is adjusted such that the circumferential velocity of the photo conductor 20Y and the circumferential velocities of the spacers 58Y on the developing roller 51Y are the same or approximately the same. Further, in this embodiment, a non-contact type developing method has been explained, but a contact type developing method may also be used.

As the toner, small grain diameter/high circle-diameter degree toner having a volume average grain diameter of 5 μm or less and an average degree of circularity of 0.95 or more is used, and an external additive such as silica, titanium, or the like is added to the outside of the toner.

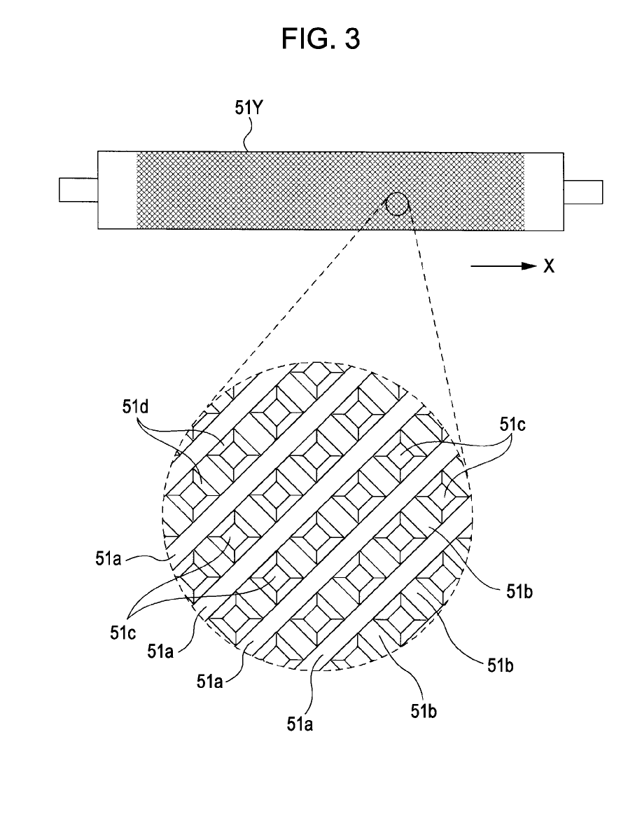

FIG. 3 is a diagram showing one example of the developing roller according to the invention along with a partly enlarged view of the surface thereof, and the partly enlarged view (in the circle of a dotted line) of FIG. 3 is an enlarged view of the surface portion of the developing roller 51Y of this embodiment.

In order to improve the transportability and the electrical charging of the toner, a first inclined groove 51a which is continuous in a helical shape inclined at a given angle with respect to an axial direction and a circumferential direction, and a second inclined groove 51b, which is continuous in a helical shape inclined with respect to the axial direction and the circumferential direction in the direction opposite to that of the first inclined groove 51a are formed so as to cross each other in the surface of the developing roller 51Y. Further, quadrangular convex portions 51c having inclined flanks 51d are formed surrounded by the first inclined groove 51a and the second inclined groove 51b. In the developing roller 51Y according to the invention, a regulating method is adopted in which toner is transported mainly in the groove portions of the first and second inclined grooves 51a and 51b which are formed in the surface of the developing roller. Since the developing roller 51Y is formed of a material able to conduct electricity such as metal or alloy including copper, aluminum, stainless steel, or the like, an image force acts between the roller and the electrically charged toner transported in the grooves, so that toner is stably transported up to a developing nip. Further, if toner of a small grain diameter, where the volume average grain diameter is equal to or less than 5 μm, is used as the toner, the image of a higher quality can be obtained. Further, since toner of a small grain diameter is able to be highly electrically charged compared with toner of a larger grain diameter, such a toner is suitable for the regulating method in which toner is transported mainly in the grooves. Further, nickel plating, chrome plating, or the like may also be carried out on the surface of the developing roller 51Y, if necessary. Also, it is preferable to use toner with an average degree of circularity of 0.95 to 0.99, preferably 0.972 to 0.983. In this case, the electrification amount can be made stable, and at the same time, transportability can also be excellent. As a method of adjusting the degree of circularity of toner, in an emulsion polymerization method, by controlling the temperature and the time in the cohesion process of secondary particles, the degree of circularity can be freely changed and made in the range of 0.94 to 1.00. In a suspension polymerization method, the preparation of the true-spherical toner is possible and the degree of circularity can be made to reach the range of 0.98 to 1.00. In order to achieve an average degree of circularity of 0.95 to 0.99, the degree of circularity can be appropriately adjusted by heating and deforming the toner at a temperature equal to or more than the Tg temperature of the toner.

In the developing roller, the first inclined groove 51a is formed to have a larger groove depth than the groove depth of the second inclined groove 51b. Conversely, the second inclined groove 51b may also be formed to have a larger groove depth than the groove depth of the first inclined groove 51a. By making the groove depths of the first and second inclined grooves 51a and 51b larger than the volume average grain diameter R of toner and enabling toner to be transported in the grooves, the toner transportation amount is secured. In the developing roller 51Y of this embodiment, toner is electrically charged by the regulating blade and also, an electric charge is imparted by frictional electrification due to the fact that toner supplied from the supply roller 52Y is brought into contact with the concave-convex shape of the developing roller 51Y. Therefore, increasing the number of toner contacts with the concave-convex shape in the groove is important for the improvement of the electrical charging.

In a case where the first and second inclined grooves 51a and 51b have the same groove depth, in order to secure the toner transportation amount, the groove depth must be a certain depth. As a result, the amount of toner passing over the groove is reduced, so that the number of toner contacts with the concave-convex shape is reduced, whereby the toner electrification amount is reduced.

In the developing roller 51Y according to the invention, since the first inclined groove 51a having a larger groove depth and the second inclined groove 51b having a smaller groove depth are formed to intersect with each other, the toner transportation amount is secured. In addition, due to the intersection of the first and second inclined grooves 51a and 51b having different groove depths, a groove step portion is formed in the grooves. Further, due to the fact that toner passes over the groove step portion, the number of toner contacts with the concave-convex shape is increased, so that the electrification amount is improved.

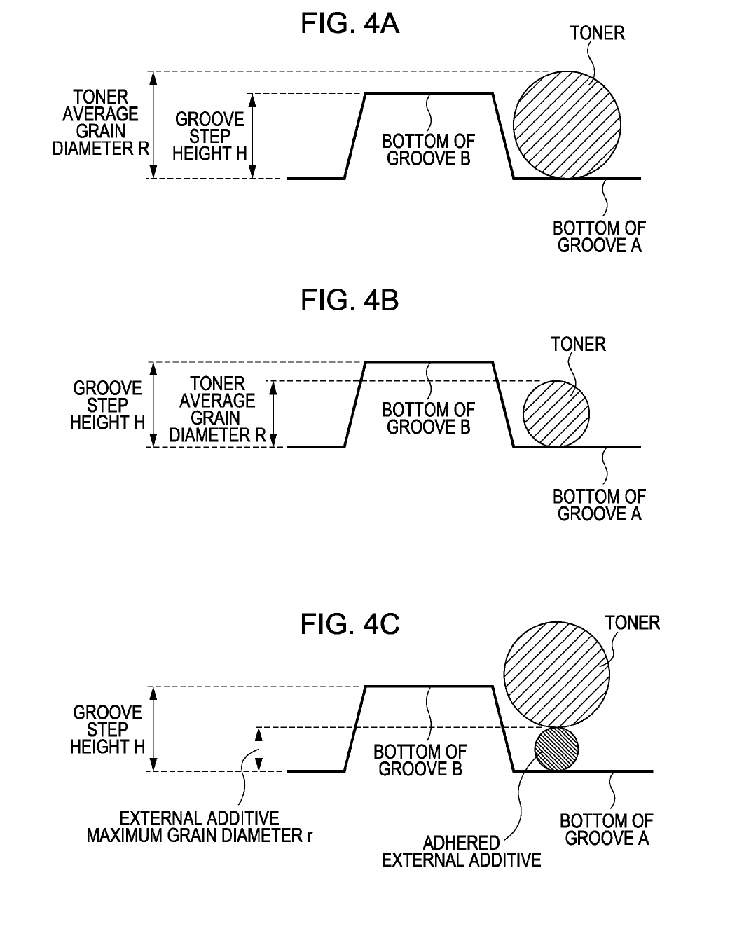

FIGS. 4A, 4B, and 4C are diagrams for explaining the action of the groove step portion formed by the intersection of the first and second inclined grooves 51a and 51b having different groove depths.

As shown in FIG. 4A, the groove step portion having a height H is formed between the bottom of the first inclined groove 51a (in the drawing, referred to as a groove A) having a larger groove depth and the bottom of the second inclined groove 51b (in the drawing, referred to as a groove B) having a smaller groove depth. If the height H of the groove step portion is smaller than the volume average grain diameter R of toner, toner easily passes over the groove step portion, so that the number of toner contacts with the concave-convex shape in the groove is increased, so that the electrification amount is increased.

As shown in FIG. 4B, if the height H of the groove step portion is larger than the volume average grain diameter R of the toner, the amount of toner passing over the groove step portion is reduced, so that the number of toner contacts with the concave-convex shape in the groove is reduced, whereby the electrification amount is lowered.

FIG. 4C is a diagram showing a state in which the height H of the groove step portion is set to be larger than the maximum grain diameter r of the external additive adhered to toner. The toner with the external additive adhered thereto is larger than the height H of the groove step portion, and thus the number of times the toner passes over the groove step portion is increased, so that the number of toner contacts with the concave-convex shape in the groove is increased, whereby the electrification amount is increased.

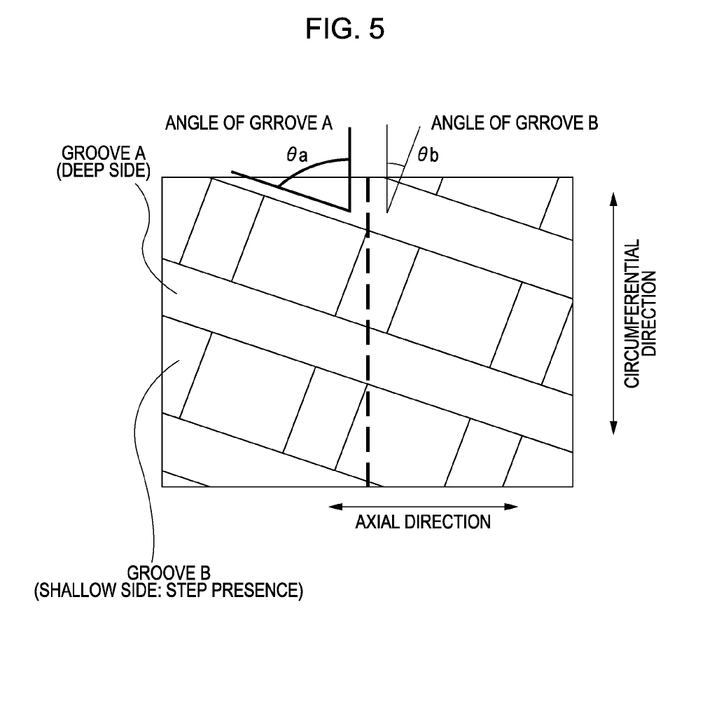

FIG. 5 is a diagram showing an example in which the inclined groove 51a having a larger groove depth (in the drawing, referred to as a groove A) and the inclined groove 51b having a smaller groove depth (in the drawing, referred to as a groove B), which are formed in the surface of the developing roller 51Y, are formed varying the angles of the grooves with respect to the circumferential direction of the developing roller 51Y. The inclined grooves are formed such that the angle θb with respect to the circumferential direction of the developing roller 51Y, of the groove B having a smaller groove depth, is smaller than the angle θa with respect to the circumferential direction of the developing roller 51Y, of the groove A having a larger groove depth. By making the angle θb with respect to the circumferential direction of the developing roller 51Y, of the groove B having a smaller groove depth, smaller, toner supplied with the rotation of the supply roller 52Y preferentially passes over the groove step portion from the groove A having a larger groove depth to the groove B having a smaller groove depth. Since the toner passes over the groove step portion, the number of toner contacts with the concave-convex shape is increased, so that the toner electrification amount can be effectively improved.

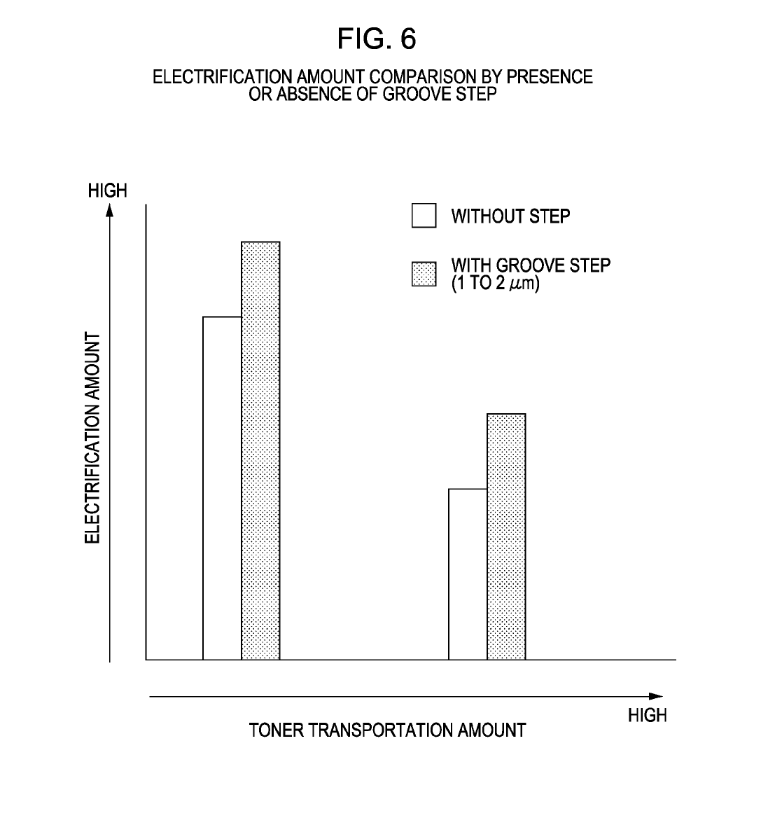

FIG. 6 is a graph showing the result of an experiment in which in the developing rollers in which the helically-shaped inclined grooves intersecting with each other and inclined with respect to the axial and circumferential directions are formed by the rolling process, the toner transportation amounts and the toner electrification amounts in the developing roller with a groove step portion, as in the invention, and the developing roller without a groove step portion are compared.

In the experiment, as toner, the small grain diameter toner having a volume average grain diameter of 5 μm or less was used, and an external additive having the maximum grain diameter of 100 num was used. Further, the experiment was conducted under the condition in which the groove depths of the inclined grooves were on average 10 μm and the height H of the groove step portion (the distance between the bottom of the groove having a larger groove depth and the bottom of the groove having a smaller groove depth) of the developing roller having the groove step portion was 1 to 2 μm.

The experiment showed that when the toner transportation amounts in the developing roller without the groove step and the developing roller with the groove step were set to be the same, the toner electrification amounts in the developing roller with the groove step portion was increased, as shown in the graph of FIG. 6. This is considered due to the fact that, when toner passes over the groove step portion, the number of toner contacts with the concave-convex shape in the groove is increased, so that the electrification amount due to friction is increased.

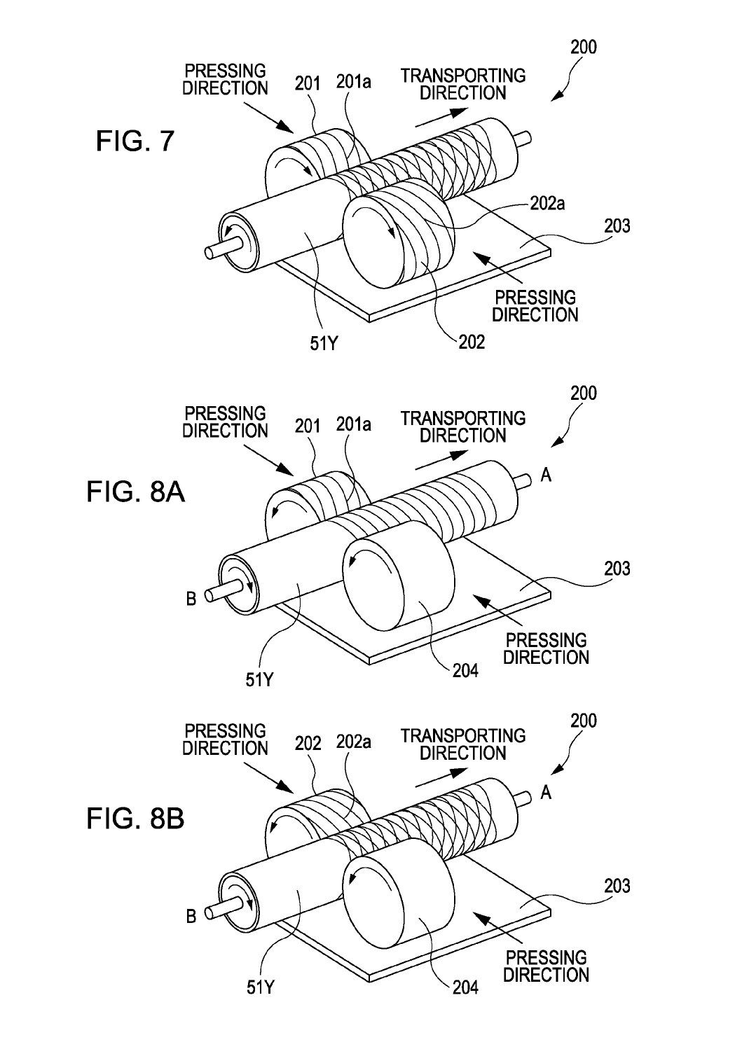

FIG. 7 is a diagram showing the a rolling process of Example 1 for forming the first and second inclined grooves 51a and 51b having different groove depths in the surface of the developing roller 51Y.

A rolling apparatus 200 used in the rolling process includes a first die 201 which has first inclined blades 201a inclined with respect to an axial direction and a circumferential direction, for forming the first inclined groove 51a in the developing roller 51Y; a second die 202 which has second inclined blades 202a inclined with respect to an axial direction and a circumferential direction in the direction opposite to that of the first inclined blade 201a, for forming the second inclined groove 51b in the developing roller 51Y; and a guide board 203 disposed below the first die 201 and the second die 202. The height at which the first inclined blade 201a protrudes from a surface is set to be larger than the height at which the second inclined blade 202a protrudes from a surface.

The rolling apparatus 200 transports and works by rolling a work piece (here, an unprocessed developing roller 51Y) between the guide board 203 and the first and second dies 201 and 202, which are disposed at positions facing each other and rotate in the clockwise direction, as indicated by an arrow. In the rolling work, the first and second dies 201 and 202 impart a working pressure of a direction which presses the unprocessed developing roller 51Y. The unprocessed developing roller 51Y is worked by rotating it in the counter-clockwise direction opposite to the rotation directions of the first and second dies 201 and 202.

The first and second inclined blades 201a and 202a for forming the above-described first and second inclined grooves 51a and 51b are respectively provided in the first and second dies 201 and 202. The first and second inclined blades 201a and 202a form the first and second inclined grooves 51a and 51b which intersect with each other, have different groove depths, and are inclined with respect to the axial and circumferential directions, and the convex portions 51c of a truncated four-sided pyramid shape having the inclined flanks 51d, in the surface of the unprocessed developing roller 51Y.

The convex portion 51c of a truncated four-sided pyramid shape has a square shape when the inclined angles of the first and second inclined grooves 51a and 51b with respect to the axial direction are 45° and the pitches of them are set to be the same as each other, and a rhombic shape when the inclined angles of the first and second inclined grooves 51a and 51b with respect to the axial direction are angles other than 45° and their pitches are set to be the same as each other. Also, the quadrangular convex portion 51c shows a rectangular shape when the inclined angles of the first and second inclined grooves 51a and 51b with respect to the axial direction are 45° and their pitches are set to be different from each other, and a parallelogram shape when the inclined angles of the first and second inclined grooves 51a and 51b with respect to the axial direction are angles other than 45° and their pitches are set to be different from each other.

Although the first and second inclined blades 201a and 202a are explained as being the sites where the first and second dies 201 and 202 are brought into contact with the surface of the unprocessed developing roller 51Y, in the rolling process, the first and second inclined blades 201a and 202a do not positively cut the work piece, but act to form depressions by crushing the work piece by a suppressing force.

Also, in this rolling process, the first and second dies 201 and 202 are not brought into contact with the opposite ends of the unprocessed developing roller 51Y, so that smooth surfaces without concavity or convexity remain on the opposite ends. That is, the convex portions 51c which have not been brought into contact with the first and second dies 201 and 202 at the central portion of the developing roller 51Y, and the opposite ends which do not become objects to be worked by the rolling process, are the non-processed surfaces.

FIGS. 8A and 8B are diagrams showing the rolling process of Example 2 for forming the first and second inclined grooves 51a and 51b having different groove depths in the surface of the developing roller 51Y.

The first rolling process of Example 2 is performed by the rolling apparatus 200 in which the first die 201 having the first inclined blades 201a and a non-bladed die 204 are disposed to face each other on the guide board 203. In this example, the distance between the grooves formed in the developing roller 51Y was set to an equal pitch. In the first rolling process, both the first die 201 and the non-bladed die 204 are rotated in the counter-clockwise direction, as indicated by an arrow in FIG. 8A. The unprocessed developing roller 51Y is transported between the first die 201 and the non-bladed die 204 on the guide board 203 with the end A side of the opposite ends A and B at the head from one side of the rolling apparatus 200, while being rotated in the clockwise direction opposite to the rotation directions of the first die 201 and the non-bladed die 204. In this rolling process, the first die 201 and the non-bladed die 204 impart a first working pressure to the unprocessed developing roller 51Y, thereby rolling-processing it. As the result of the first rolling process, the first inclined groove 51a which is continuous in a helical shape is formed in the developing roller 51Y.

The second rolling process of Example 2 uses the rolling apparatus in which the first die 201 of the rolling apparatus 200 used in the first rolling process has been replaced with the second die 202 having the second inclined blades 202a which are inclined in the direction opposite to that of the first inclined blade 201a. In this example, the distance between the grooves formed in the developing roller 51Y by the second inclined blade 202a was set to an equal pitch. In the second rolling process, both the second die 202 and the non-bladed die 204 are rotated in the counter-clockwise direction which is the same as that in the first rolling process, as indicated by an arrow in FIG. 8B. The developing roller 51Y, in which the first inclined groove 51a has been formed, is rotated in the clockwise direction opposite to the rotation directions of the second die 202 and the non-bladed die 204. In the rolling process, the second die 202 and the non-bladed die 204 impart a second working pressure which is smaller than the first working pressure of a direction which presses the developing roller 51Y.

As the result of the second rolling process, the second inclined groove 51b which intersects with the first inclined groove 51a that is continuous in a helical shape is formed in the developing roller 51Y. Since the first working pressure at the time when forming the first inclined groove 51a is larger than the second working presses at the time when forming the second inclined groove 51b, the groove depth of the first inclined groove 51a is formed to be larger than the groove depth of the second inclined groove 51b.

The entire disclosure of Japanese Patent Application No. 2008-315586, filed Dec. 11, 2008 is expressly incorporated by reference herein.

What is claimed is:

1. A developing roller having a first inclined groove and a second inclined groove, which are continuous in a helical shape inclined with respect to an axial direction and a circumferential direction and which intersect with each other, formed in the surface thereof, wherein the first inclined groove and the second inclined groove have different groove depths.

2. The developing roller according to claim 1, wherein the groove depths of the first and second inclined grooves are larger than the volume average grain diameter of toner.

3. The developing roller according to claim 1, wherein the height of a groove step portion formed at the intersection portion of the first and second inclined grooves having different groove depths is smaller than the volume average grain diameter of toner and larger than the maximum grain diameter of an external additive.

4. The developing roller according to claim 1, wherein the angle θb of the inclined groove having a smaller groove depth, of the first and second inclined grooves, with respect to the circumferential direction of the developing roller is smaller than the angle θa of the inclined groove having a larger groove depth with respect to the circumferential direction of the developing roller.

5. The developing roller according to claim 1, wherein toner is transported in the groove portions of the first and second inclined grooves.

6. The developing roller according to claim 1, wherein as toner, a small grain diameter toner having the volume average grain diameter of 5 μm or less is used.

7. A developing device comprising:
a supply roller which supplies toner;
a developing roller to which toner is supplied from the supply roller; and
a regulating blade which comes into contact with the developing roller, thereby regulating the total thickness of toner on the developing roller,
wherein as the developing roller, the developing roller according to claim 1 is used.

8. An image forming apparatus comprising:
a latent image supporting body on which an electrostatic latent image is formed;
a developing device which develops a toner image on the latent image supporting body by developing the electrostatic latent image by using toner; and
a transferring device which transfers the toner image on the latent image supporting body to a transfer medium,
wherein the developing device is the developing device according to claim 7.
